(19) United States
(12) Patent Application Publication
(10) Pub. No.: US 2008/0282178 A1
(43) Pub. Date: Nov. 13, 2008

(54) METHOD AND SYSTEM TO PROVIDE NOTIFICATION OF MESSAGES AND PROMPTS ASSOCIATED WITH APPLICATIONS

(76) Inventors: Angela Richards Jones, Durham, NC (US); Kaushik Patel, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/745,901

(22) Filed: May 8, 2007

(51) Int. Cl. G06F 15/16; G06F 3/048

(52) U.S. Cl. 715/765; 709/206

(57) ABSTRACT

A method of providing notification of messages and prompts associated with applications. When an application executing on a computer generates a prompt while the computer is unattended, a prompt notification program (PNP) sends descriptive information that corresponds to the prompt from the computer to a mobile messaging device. The mobile messaging device utilizes a graphical user interface (GUI) to display a screenshot of the prompt, and the mobile messaging device enables a user to enter a response to the prompt. Possible responses include, but are not limited to, a “yes” response, a “no” response, an “ignore” response, and a customized text response. The PNP receives the response to the prompt from the mobile messaging device, and the PNP provides the response to the application that generated the prompt.

### BACKGROUND OF THE INVENTION

1. Technical Field

The present invention relates in general to data processing systems and in particular to application programs. Still more particularly, the present invention relates to an improved method and system for providing notification of messages and prompts associated with applications.

2. Description of the Related Art

In today's on-demand culture, computer users want information instantly. Computer users also typically want to be in control of computer applications. However, computer users do not want to be constrained to sitting in front of a computer for long periods of time. Consequently, computer users often leave their computers running even when the user is not sitting in front of the computer.

Computer applications typically generate multiple dialog boxes to automatically inform a user of the status of a task and/or to prompt the user for information. During the execution of some tasks (e.g., installing an application), the task may be placed in a suspended state after a dialog box is generated, and the task may not resume execution until a user provides input in response to the dialog box. An installation application may thus be delayed if a user does not provide input to answer a prompt. The potential for delay is even more substantial in enterprise settings, where large applications and/or solutions can take several hours to install.

### SUMMARY OF AN EMBODIMENT

Disclosed are a method, system, and computer storage medium for providing notification of messages and prompts associated with applications. When an application executing on a computer generates a prompt while the computer is unattended, a prompt notification program (PNP) sends descriptive information that corresponds to the prompt from the computer to a mobile messaging device. The mobile messaging device utilizes a graphical user interface (GUI) to display a screenshot of the prompt, and the mobile messaging device enables a user to enter a response to the prompt. Possible responses include, but are not limited to, a “yes” response, a “no” response, an “ignore” response, and a customized text response. The PNP receives the response to the prompt from the mobile messaging device, and the PNP provides the response to the application that generated the prompt.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary computer, according to an embodiment of the present invention;

FIG. 2 illustrates an exemplary graphical user interface (GUI), according to an embodiment of the present invention; and

FIG. 3 is a high level logical flowchart of an exemplary method of providing notification of messages and prompts associated with applications, according to an embodiment of the invention.

### DETAILED DESCRIPTION OF AN ILLUSTRATIVE EMBODIMENT

The present invention provides a method, system, and computer storage medium for providing notification of messages and prompts associated with applications.

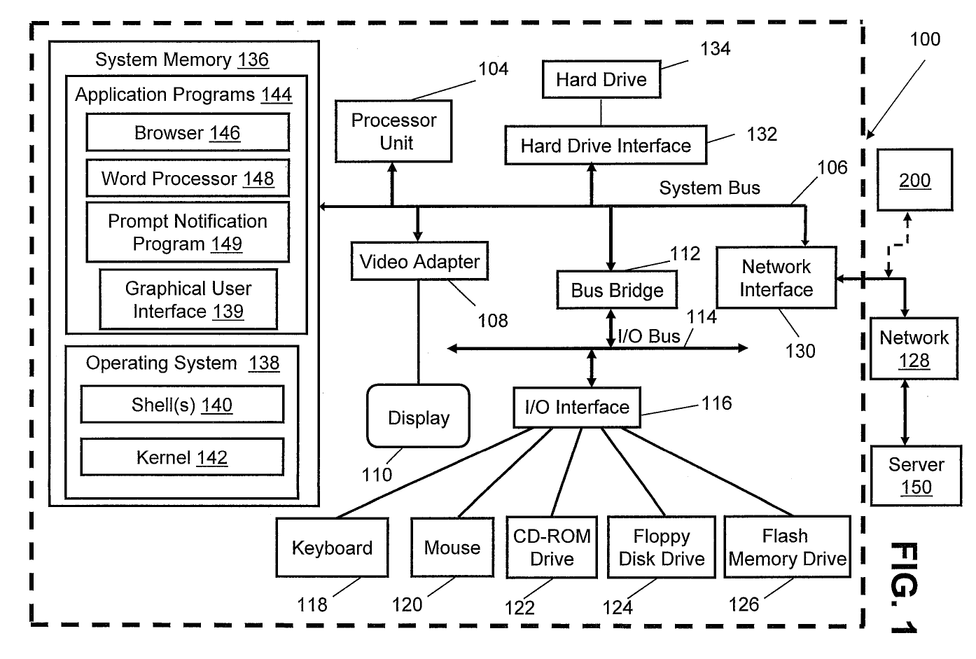

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash memory drive 126. The format of the ports connected to I/O interface 116 may be any known to those skilled in the art of computer architecture, including but not limited to Universal Serial Bus (USB) ports.

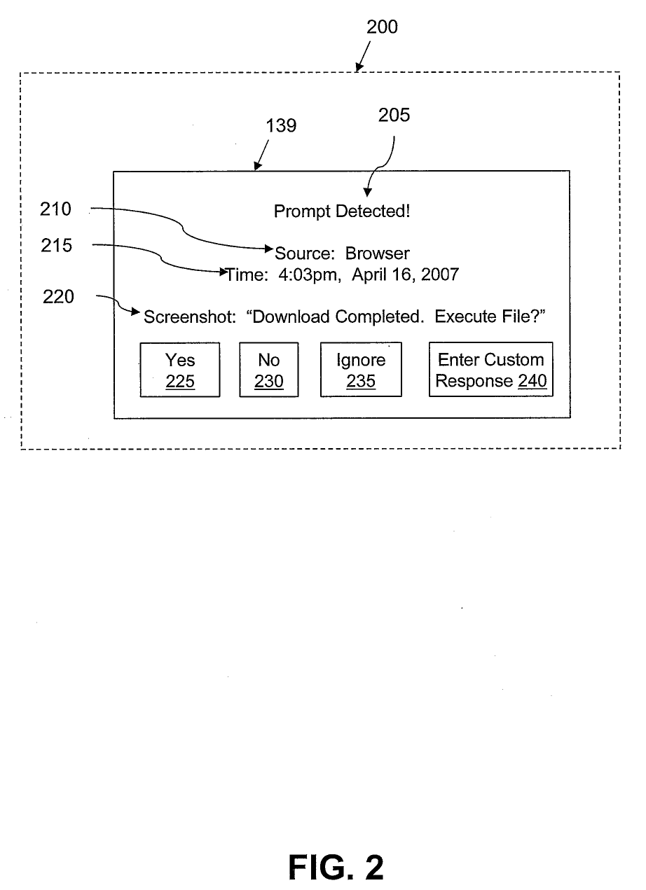

Computer 100 is able to communicate with a server 150 via a network 128 using a network interface 130, which is coupled to system bus 106. Network 128 may be an external network such as the Internet, or an internal network such as an Ethernet or a Virtual Private Network (VPN). Computer 100 also utilizes network 128 to communicate wirelessly with a mobile messaging device 200. Mobile messaging device 200 has a configuration similar to computer 100 and is illustrated in FIG. 2, which is discussed below.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144. System memory 136 also includes a graphical user interface (GUI) 139 that is illustrated in FIG. 2, which is discussed below.

OS 138 includes a shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

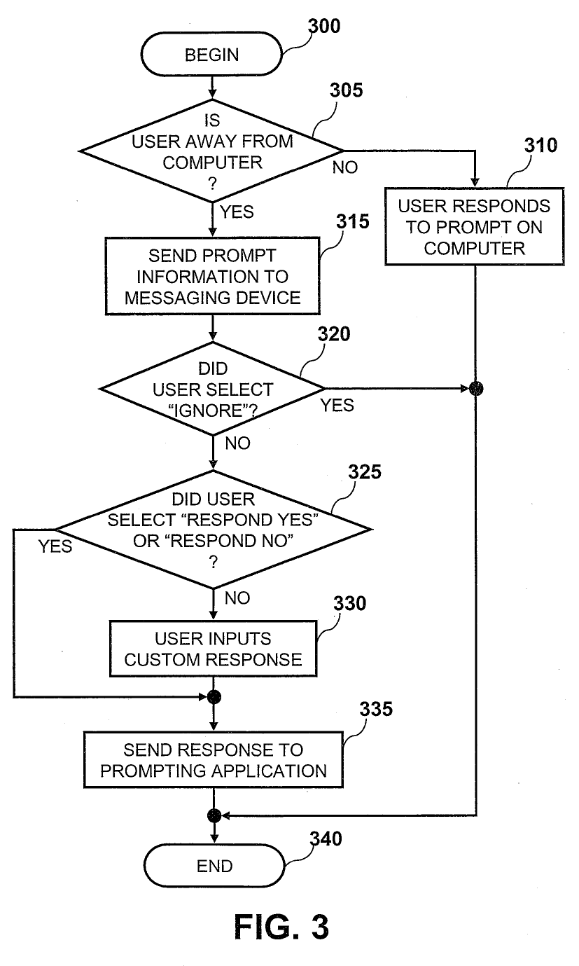

Application programs 144 include a browser 146, a word processor 148, and a prompt notification program (PNP) 149 that performs the functions illustrated in FIGS. 2 and 3, which are discussed below. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150, which has a configuration similar to computer 100.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

With reference now to FIG. 2, there is depicted an exemplary GUI, according to an embodiment of the present invention. As shown, GUI 139 (from FIG. 1) is displayed on mobile messaging device 200. As utilized herein, a mobile messaging device refers to a mobile wireless communication device that is capable of displaying a GUI, including, but not limited to, a mobile phone, a personal digital assistant (PDA), a pager, a laptop computer, or a tablet computer. PNP 149 transmits GUI 139 to mobile messaging device 200 according to the method illustrated in FIG. 3, which is discussed below.

Returning now to FIG. 2, GUI 139 includes an alert field 205, a source field 210, a time field 215, and a prompt screenshot 220. Alert field 205 notifies a user of mobile messaging device 200 that one of application programs 144 has generated a prompt. Source field 210 contains identification information corresponding to the particular application that generated the prompt detected by PNP 149. Time field 215 contains a time stamp that enables the user to determine the time and date on which PNP 149 detected the prompt. Prompt screenshot 220 contains the images and/or text of the detected prompt.

In one embodiment, GUI 139 includes multiple graphical response buttons, including, but not limited to, a “yes” button 225, a “no” button 230, an “ignore” button 235, and an “enter custom response” button 240. Yes button 225 enables a user of mobile messaging device 200 to respond to a prompt by accepting a task and/or answering a question affirmatively. Similarly, no button 230 enables a user of mobile messaging device 200 to respond to a prompt by declining a task and/or answering a question negatively. Ignore button 235 enables a user of mobile messaging device 200 to temporarily take no action (e.g., if the user chooses to wait until they return to computer 100 to respond to the prompt). Enter custom response button 240 enables a user of mobile messaging device 200 to enter a customized text message for a particular prompt that requires a more detailed answer than yes or no (e.g., a prompt asking a user to provide a destination folder for an installation).

Turning now to FIG. 3, there is illustrated a high level logical flowchart of an exemplary method of providing notification of messages and prompts associated with applications, according to an embodiment of the invention. The process begins at block 300 in response to one of application programs 144 (from FIG. 1) generating a prompt. PNP 149 determines whether the user is away from computer 100 (e.g., by using a timeout mechanism, motion detection device, heat sensor, pressure sensor, carbon dioxide detection device, or the like), as depicted in block 305. If the user is not away from computer 100, PNP 149 enables the user to respond to the prompt at computer 100, as shown in block 310, and the process terminates at block 340. If the user is away from computer 100, PNP 149 utilizes GUI 139 and network 128 to send information corresponding to the prompt from computer 100 to mobile messaging device 200, as depicted in block 315. As illustrated in FIG. 2, which is described above, information corresponding to the prompt may include a screenshot (i.e., a graphical image) of the prompt and/or descriptive text.

At block 320, mobile messaging device 200 determines whether a user has responded to the prompt by selecting ignore button 235. If a user has selected ignore button 235, the process terminates at block 340. If a user has not selected ignore button 235, mobile messaging device 200 determines whether a user has selected yes button 225 or no button 230, as shown in block 325. If a user has selected yes button 225 or no button 230, mobile messaging device 200 sends the response that corresponds to the selected button (i.e., yes or no) to computer 100, and PNP 149 provides the response to the application that generated the prompt, as depicted in block 335. The process subsequently terminates at block 340.

If a user of mobile messaging device 200 has not selected yes button 225 or no button 230 (i.e., the user selected enter custom response button 240), mobile messaging device 200 receives customized text input from the user, as depicted in block 330. Mobile messaging device 200 sends the customized text response to computer 100, and PNP 149 provides the response to the application that generated the prompt, as depicted in block 335. The process subsequently terminates at block 340.

In an alternate embodiment, if a user of mobile messaging device 200 must return to computer 100 in order to take action in response to a prompt (e.g., if a system reset is required), the process terminates after block 315 once PNP 149 sends information corresponding to the prompt from computer 100 to mobile messaging device 200 (i.e., remote user input is not obtained and/or an “ignore” response is assumed). In another embodiment, a user of computer 100 can store pre-defined preferences within system memory 136, including which types of prompts the user would like to be remotely notified of (e.g., receiving warning/error messages but not informational messages), as well as one or more particular applications that the user would and/or would not like to remotely receive prompts from (e.g., receiving all messages from “push” applications that automatically installs system patches). In yet another embodiment, the functions performed by PNP 149, as described above in FIG. 3, may instead be performed by OS 138.

The present invention thus enables a user of computer 100 to temporarily leave computer 100 while remaining informed in real time via mobile messaging device 200 of any prompts generated by application programs 144 that are executing on computer 100. When an application executing on computer 100 generates a prompt while computer 100 is unattended, PNP 149 sends descriptive information that corresponds to the prompt from computer 100 to mobile messaging device 200. Mobile messaging device 200 utilizes GUI 139 to display screenshot 220 of the prompt, and mobile messaging device 200 enables a user to enter a response to the prompt. Possible responses include, but are not limited to, a yes response, a no response, an ignore response, and a customized text response. PNP 149 receives the response to the prompt from mobile messaging device 200, and PNP 149 provides the response to the application that generated the prompt.

It is understood that the use herein of specific names are for example only and not meant to imply any limitations on the invention. The invention may thus be implemented with different nomenclature/terminology and associated functionality utilized to describe the above devices/utility, etc., without limitation.

In the flow chart (FIG. 3) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
in response to a determination that an application executing on a computer generates a prompt while said computer is unattended, sending descriptive information that corresponds to said prompt from said computer to a mobile messaging device;
receiving input that comprises a response to said prompt from said mobile messaging device; and
providing said input to said application.

2. The method of claim 1, wherein said descriptive information further comprises a graphical user interface (GUI) that includes a screenshot of said prompt.

3. The method of claim 1, wherein said input is selected from a group that includes:
a yes response,
a no response,
an ignore response, and
a customized text response.

4. A computer system comprising:
a processor unit;
a memory coupled to said processor unit;
a plurality of application programs within said memory;
an operating system (OS) within said memory;
a network interface coupled to said processor unit, wherein said network interface enables said OS to communicate with a mobile messaging device;
means for sending descriptive information that corresponds to a prompt from said computer to said mobile messaging device in response to a determination that one of said plurality of application programs executing on said computer generates said prompt while said computer is unattended;
means for receiving input that comprises a response to said prompt from said mobile messaging device; and
means for providing said input to said application program.

5. The computer system of claim 4, wherein said means for sending said descriptive information further comprises a graphical user interface (GUI) that includes a screenshot of said prompt.

6. A computer storage medium encoded with a computer program that, when executed, performs the steps of:
in response to a determination that an application executing on a computer generates a prompt while said computer is unattended, sending descriptive information that corresponds to said prompt from said computer to a mobile messaging device;
receiving input that comprises a response to said prompt from said mobile messaging device; and
providing said input to said application.
